(19) United States
(12) Patent Application Publication
(10) Pub. No.: US 2014/0351436 A1
(43) Pub. Date: Nov. 27, 2014

(54) ENDPOINT MANAGEMENT BASED ON ENDPOINT TYPE

(71) Applicant: International Business Machines Corporation, Armonk, NY (US)

(72) Inventor: Jeffrey W. Tenner, Rochester, MN (US)

(73) Assignee: International Business Machines Corporation, Armonk, NY (US)

(21) Appl. No.: 14/056,981

(22) Filed: Oct. 18, 2013

Related U.S. Application Data
(63) Continuation of application No. 13/899,183, filed on May 21, 2013.

(51) Int. Cl. H04L 12/911

(52) U.S. Cl. CPC H04L 47/70
USPC 709/226

(57) ABSTRACT

Techniques are disclosed to facilitate endpoint management based on endpoint type. Counts of endpoints currently managed by an application are provided for each endpoint type. Weights are provided that each represent a measure of resource consumption by the application in managing an endpoint of a respective endpoint type. A count of additional endpoints of a first endpoint type is determined based on a capacity of a set of available resources. The count is used to facilitate usage of the predefined capacity of the set of available resources.

### CROSS-REFERENCE TO RELATED APPLICATION

This application is a continuation of co-pending U.S. patent application Ser. No. 13/899,183, filed May 21, 2013. The aforementioned related patent application is herein incorporated by reference in its entirety.

### BACKGROUND

1. FIELD

Embodiments disclosed herein relate to facilitating endpoint management based on endpoint type. More specifically, embodiments disclosed herein relate to facilitating usage of a set of resources available to an application configured to manage endpoints of different endpoint types.

2. Description of the Related Art

There are many types of computing systems, each having its own set of features, capabilities and advantages. As examples, there are general-purpose systems optimized for a broad set of applications or components, and special-purpose systems and accelerators optimized for a specific set of applications or components. Each type of system is defined, in part, by the instruction set architecture that it implements, and each is distinct from the others.

The general-purpose systems may include, for instance, mainframe computers able to provide high-end, high-availability, reliable services, and/or modular systems, and the special-purpose systems may include co-processors configured to perform specific tasks. Each system manages its workload in its own individual manner and is separately responsible for performing requested services. Typically, each of the systems introduces its own specific administration model, resulting in system-specific management tooling, forming separate and distinct management silos.

### SUMMARY

Embodiments presented in this disclosure provide a computer-implemented method to facilitate endpoint management based on endpoint type. The method includes providing, by an application, endpoint counts including, for each of multiple endpoint types, a count of endpoints of the respective endpoint type, currently managed by the application, the application having access to a set of resources of a given capacity. The method also includes providing weights including a respective weight for each of the endpoint types. Each weight represents a measure of resource consumption by the application in managing an endpoint of the respective endpoint type. The weights include at least two distinct weights. The method also includes determining, for at least a first endpoint type of the endpoint types, a count of additional endpoints of the first endpoint type, potentially managed by the application, based on the given capacity of the set of resources. The method also includes outputting the count of additional endpoints of the first endpoint type, where the count of additional endpoints of the first endpoint type is used in order to facilitate usage of the given capacity of the set of resources to which the application has access.

Other embodiments presented in this disclosure provide a computer program product to facilitate endpoint management based on endpoint type. The computer program product includes a computer-readable storage medium having embodied therewith program code of an application. The program code is executable by one or more computer processors to provide endpoint counts including, for each of multiple endpoint types, a count of endpoints of the respective endpoint type, currently managed by the application, the application having access to a set of resources of a given capacity. The program code is also executable to provide weights including a respective weight for each of the endpoint types. Each weight represents a measure of resource consumption by the application in managing an endpoint of the respective endpoint type. The weights include at least two distinct weights. The program code is also executable to determine, for at least a first endpoint type of the endpoint types, a count of additional endpoints of the first endpoint type, potentially managed by the application, based on the given capacity of the set of resources. The program code is also executable to output the count of additional endpoints of the first endpoint type, where the count of additional endpoints of the first endpoint type is used in order to facilitate usage of the given capacity of the set of resources to which the application has access.

Still other embodiments presented in this disclosure provide a system to facilitate endpoint management based on endpoint type. The system includes one or more computer processors and a memory containing an application which, when executed by the one or more computer processors, is configured to perform an operation that includes providing, by an application, endpoint counts including, for each of multiple endpoint types, a count of endpoints of the respective endpoint type, currently managed by the application, the application having access to a set of resources of a given capacity. The operation also includes providing weights including a respective weight for each of the endpoint types. Each weight represents a measure of resource consumption by the application in managing an endpoint of the respective endpoint type. The weights include at least two distinct weights. The operation also includes determining, for at least a first endpoint type of the endpoint types, a count of additional endpoints of the first endpoint type, potentially managed by the application, based on the given capacity of the set of resources. The operation also includes outputting the count of additional endpoints of the first endpoint type, where the count of additional endpoints of the first endpoint type is used in order to facilitate usage of the given capacity of the set of resources to which the application has access.

### BRIEF DESCRIPTION OF THE SEVERAL VIEWS OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a data flow diagram of an application configured to facilitate endpoint management based on endpoint type, according to one embodiment presented in this disclosure.

FIG. 2 is a flowchart depicting a method to facilitate endpoint management based on endpoint type, according to one embodiment presented in this disclosure.

FIG. 3 is a flowchart depicting a method to determine a maximum count of additional endpoints potentially managed, according to one embodiment presented in this disclosure.

FIG. 4 is a block diagram illustrating components of a networked system configured to facilitate endpoint management based on endpoint type, according to one embodiment presented in this disclosure.

FIG. 5 is a schematic of a cloud computing node endpoint to be managed by the application, according to one embodiment presented in this disclosure.

FIG. 6 illustrates a cloud computing environment including endpoints to be managed by the application, according to one embodiment presented in this disclosure.

FIG. 7 illustrates a set of functional abstraction layers provided by a cloud computing environment having endpoints to be managed by the application, according to one embodiment presented in this disclosure.

### DETAILED DESCRIPTION

At least some embodiments presented in this disclosure provide techniques to facilitate endpoint management based on endpoint type. One embodiment provides an application configured to manage endpoints of different endpoint types. The application may have access to a given set of resources, such as a set of available resources on a management appliance on which the application is configured to execute. As used herein, an endpoint refers to any resource-consuming entity operatively connected to the application and that includes software, firmware, hardware, or a combination thereof. Examples of endpoints include hardware endpoints, operating system endpoints, and virtual endpoints. At least in some embodiments, hardware endpoints include chassis, switches, information technology elements (ITEs) such as blades; virtual endpoints include virtual servers and virtual switches; and operating system endpoints include guest operating systems executing on a virtual server and host operating systems executing on a physical server.

In one embodiment, managing an endpoint refers to performing one or more operations to set, retrieve, or modify an aspect of the endpoint. For example, the operations may include configuring an endpoint, monitoring an endpoint, reconfiguring an endpoint, etc. Depending on the embodiment, the operations may be performed based on user input or exclusive of any user input. Further, operations to manage an endpoint may be classified into different types. For example, the application may perform operations for workload optimization, interface unification, compute management, storage management, network management, and/or virtualization management, respectively, each of which is described in further detail as follows.

Workload optimization is performed to distribute a desired workload across a desired set of endpoints in a manner such that the desired workload is performed efficiently, given existing workload and resource constraints associated with the endpoints. The application creates or modifies system pools based on workloads, adjust workloads in real-time, and move workloads within system pools, to improve resilience of the virtual environment against scheduled or unscheduled down time. A system pool refers to a group of virtualized system components that are managed as a single entity, allowing the group to be managed with the increased convenience of managing a single entity. Performing workload optimization may serve to decrease infrastructure costs and/or improve service levels in some cases.

Interface unification is performed to provide a single, unified interface to facilitate multi-chassis management, the unified interface providing an integrated, virtualized management environment across servers, storage, and networking endpoints, including both physical and virtual endpoints, in a platform-independent manner. The application outputs, on-demand and via the unified interface, real-time information regarding resources associated with compute nodes in a networked environment. The application also facilitates managing and deploying workloads across endpoints based on resource availability and/or predefined policies. The application also facilitates managing events and alerts to increase system availability. At least in some cases, the application also reduces the amount of user intervention required in managing a set of desired endpoints. By providing the unified interface, the application facilitates managing the compute nodes and resources associated therewith more conveniently and/or efficiently—at least relative to alternative approaches involving disparate, platform-specific interfaces for each of servers, storage, and networking, including disparate interfaces for physical and virtual endpoints.

Compute management is performed to discover, configure, and deploy compute node endpoints and, for deployed endpoints, monitor and provide real-time updates on the health status of the deployed endpoints. In some embodiments, the application triggers alerts based on user- or system-defined performance thresholds. The application is also configured to detect errors associated with system resources. In some embodiments, the application is further configured to programmatically resolve a set of predefined error types and without requiring user intervention. Doing so may reduce occurrences of system outages at least in some cases.

Storage management is performed to address storage challenges stemming from device deployment and through the data life cycle. Operations for storage management include storage device discovery, logical and physical device configuration, provisioning capabilities, and providing physical and logical storage topology views that include relationships between storage and server resources, which provide an ability to track resources based on business usage. Provisioning capabilities include image management for virtual machine creation, deployment and cloning. Storage system pools may also be configured for data life cycle management and for storage placement based on business policies.

Network management is performed to allow virtualized compute and storage resources to communicate with one another and to function in a given network environment, such as the cloud. The application provides end-to-end network management from the unified interface and supports automated network discovery to speed deployments. The application also provides network views via the unified interface. The application also pools and virtualizes network resources, as part of network management. The application also provides logical network profiles, thereby facilitating configuration of network connectivity characteristics of virtual machines. The application also provides automatic provisioning and movements of virtual local area networks (LANs) for virtual machines and manages media access control (MAC) addresses for virtual network interface cards. The application also provides network usage and performance statistics for virtual machines and physical compute nodes, so that network resources may be tracked and managed based on business needs.

Virtualization management includes provisioning, deployment, and managing virtual servers based on pooled resources. In one embodiment, the application is also configured to provide dynamic virtual machine placement, automated virtual machine optimization, and resource balancing. Doing so may improve the uptime of virtual machines, improve virtual machine mobility, and provide support for non-disruptive updates to the virtual machines at least in some cases.

In some embodiments, management of some endpoints may have higher processing and resource consumption requirements than other endpoints. For example, host operating systems may execute a large number of applications with multiple interdependencies. Guest operating systems may be even more complex due at least in part to relationships between virtual servers and physical servers. In some embodiments, users of the application may specify which endpoints are to be managed by the application. For instance, a first user may desire to only manage hardware endpoints via the application, while a second user may desire to manage hardware endpoints and virtual servers via the application.

In embodiments where the application has access to a given set of resources, the set of resources may impose constraints on how many endpoints the application can manage. At least in such embodiments, the application may be configured to determine and convey measures of resource utilization of the application, such as processor utilization, memory utilization, storage utilization, and network utilization. However, due to differences in processing and resource consumption requirements of different endpoints, the total number of endpoints and/or additional number of endpoints that may be managed by the application may not necessarily be readily determined, at least in some cases.

For example, assume that the application executes on a management appliance having predefined hardware capabilities. Because the hardware capabilities constitute a fixed set of resources, the hardware capabilities allow the application to support managing, as a practical matter, only up to a predefined, maximum number of endpoints. To manage additional endpoints beyond the maximum number, the hardware capabilities of the management appliance may be upgraded, or additional management appliances may be provided, that interoperate with the management appliance. By determining the total number of endpoints and/or additional number of endpoints that may be managed by the application according to the techniques disclosed herein, users may more readily and accurate ascertain when a management appliance should be upgraded—or additional management appliances should be obtained—in order to support managing a desired number of endpoints. In this regard, the appliance may be regarded as a self-assessing network monitoring appliance with an ability to assess its own capability to monitor one or more additional endpoints in the network.

Further, as used herein, managing a given endpoint by an application does not necessarily imply that the application is continuously issuing operations thereto and consuming resources at a fixed rate as a result, because the operations may be issued periodically, sporadically, in spurts, etc. In other words, managing a given endpoint by an application does not necessarily imply that a fixed portion of the current level of utilization of the application is always attributable to the given endpoint. Instead, it is assumed that each endpoint of a given type places a resource burden on the application, that is measured over a predefined period of time. Because time periods that are too short in duration may skew estimates of the resource burden placed on the application by the endpoint, it may be preferable to defined the period of time to be sufficiently lengthy to accurately represent the resource burden placed on the application.

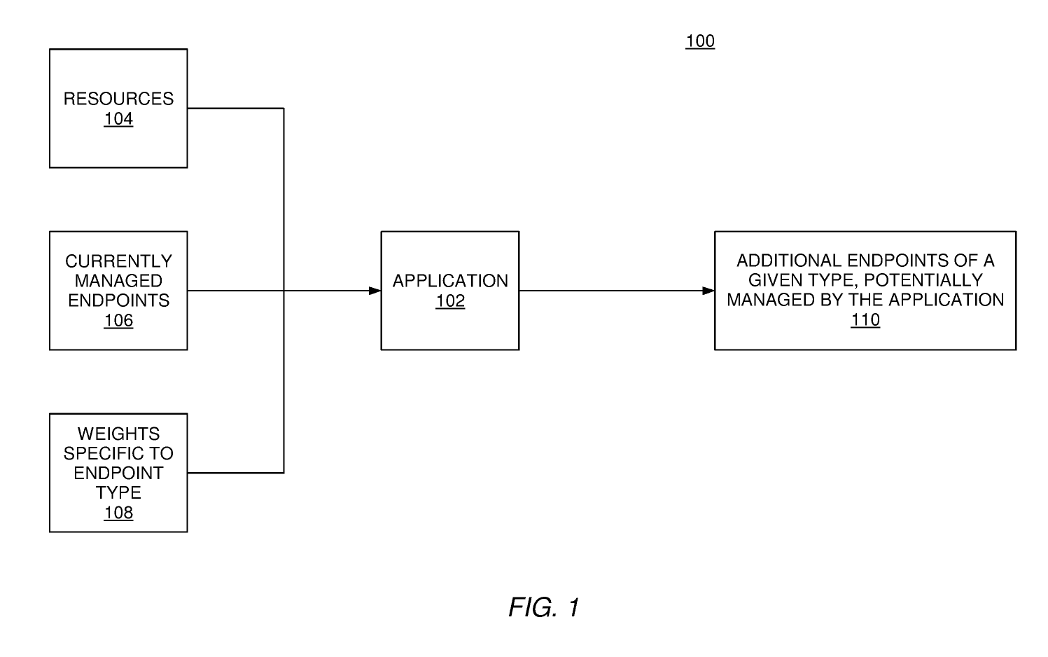

FIG. 1 is a data flow diagram 100 of an application 102 configured to facilitate endpoint management based on endpoint type, according to one embodiment presented in this disclosure. Here, the application 102 is configured to determine information such as the total number(s) of endpoints of different types and/or additional number(s) of endpoints of different types, that may be managed by the application given the set of resources to which the application has access. The additional number of endpoints refers to a number of endpoints in addition to those already being managed by the application. The determined information is subsequently used to guide how many additional endpoints the application 102 should manage. To that end, the determined numbers may be conveyed to one or more users of the application 102. In embodiments where the application 102 executes on a management appliance, doing so may facilitate resource capacity planning of the management appliance. For example, it may be more readily or accurately ascertained when management appliance upgrades or purchases may be required in order to support managing an additional, desired endpoint.

In one embodiment, to determine the information, the application 102 provides a set of weights, each weight specific to a respective endpoint type. Depending on the embodiment, the weight for a given endpoint type represents a measure of resource consumption or burden on the part of the application in order to manage endpoints of the given endpoint type, relative to endpoints of other types, where the resources consumed include processor, memory, storage, or network resources, or a combination thereof. As such, the measure of resource consumption may be regarded as a measure of the amount of processing required on the part of the application in order to assume the responsibility of managing a newly added endpoint of a given type, relative to other types. The measure of resource consumption may also be regarded as a measure of complexity of the newly added endpoint of the given type, in terms of additional resource constraints imposed onto the application, relative to other types. Further, each weight may be a numeric value. At least in some embodiments, a relatively higher weight is used to represent a first endpoint type associated with higher resource consumption, while a relatively lower weight is used to represent a second endpoint type associated with lower resource consumption.

In some embodiments, the weights may be determined based on performance metrics generated from executing one or more benchmarks. The one or more benchmarks may simulate operation of the application using the given set of resources. The performance metrics may include response time, path length, and resource utilization. Response time provides a measure of responsiveness of the application during execution of the benchmarks. Path length refers to a count of processor instructions issued in order for the application to process a given message during execution of the benchmarks. Resource utilization conveys an extent to which resources are consumed by the application during execution of the benchmarks.

In some embodiments, one or more resource capacity thresholds may also be determined from the performance metrics. Each resource capacity threshold represents a predefined measure of utilization of the given set of resources. The one or more resource capacity thresholds may include a maximum resource capacity threshold and one or more low or medium resource capacity thresholds.

In some embodiments, one or more resource capacity thresholds may be represented as a predefined function of: (i) endpoint counts of each endpoint type and (ii) associated weights, where the predefined function is a weighted sum. Proposed and/or current measures of resource utilization of the management appliance may also be determined based on the predefined function. As used herein, a proposed measure of resource utilization refer to a given measure of resource utilization that is user-defined or programmatically determined, and for which the application, upon detecting that the current measure of resource utilization exceeds the given measure of resource utilization, outputs an indication to the user that the proposed measure is exceeded. Doing so can alert the user to scenarios in which resource utilizations are higher than desired by the user. In some embodiments, multiple distinct proposed measures of resource utilization may also be provided. The predefined function may be tailored to suit the needs of a particular case. For example, rather than directly using the weights as coefficients in the weighted sum, a mathematical function of the weights may be used as the coefficients. For instance, a multiplication or exponentiation operation may first be applied to the weights, the results thereof subsequently being used in the weighted sum calculation. In other embodiments, other predefined functions may be used, such as a weighted product.

In one embodiment, to facilitate resource planning of the given set of resources, the application 102 provides patterns specifying ratios of endpoint instances of different types, also referred to herein as management patterns. In some embodiments, the patterns may be generated based at least in part on input from a given user, such as an administrator or developer of the application 102. Based on the specified ratios and weight factors, the application 102 may output or convey information on how much capacity remains in the management appliance for a given pattern. In some embodiments, in conjunction with measures of resource utilization of the management appliance, the resource capacity threshold aid end-users of the application 102 in planning for the number of additional management appliances needed as the number of endpoints being managed grows.

As stated above, in one embodiment, the application 102 provides a set of weights, each weight specific to a respective endpoint type, where the weights may be determined based on performance metrics generated from executing one or more benchmarks representing usage of the management appliance. Table I shows examples of endpoint types and associated weights.

TABLE I
Example endpoint types and weights

Host operating system - weight of 3
Guest operating system - weight of 4
Chassis - weight of 1
Blade - weight of 1
Switch - weight of 1
Virtual server - weight of 1

As stated above, in one embodiment, a proposed measure of resource utilization may be computed based on a weighted sum of endpoint types, counts, and weights of endpoints currently managed by the application 102. In one embodiment, one or more benchmarks may be used to determine how many weighted endpoints can be managed by the application 102 using the given set of resources. This determination may be expressed as one or more resource capacity thresholds.

Table II shows medium and maximum resource capacity thresholds, associated with value ranges labeled green, yellow, and red, respectively. In some embodiments, indications of the resource capacity thresholds and/or the value ranges may be output for display to one or more users of the application 102. The thresholds, value ranges, and labels may be tailored to suit the needs of a particular case.

TABLE II
Example resource capacity thresholds

If weighted endpoints < medium threshold
of 16,000, output indication of green value range.
If weighted endpoints > medium threshold
of 16,000 and < maximum threshold of 20,000,
output indication of yellow value range.
If weighted endpoints > maximum threshold
of 20,000, output indication of red value range.

In one embodiment, the resource capacity thresholds shown in Table II may be applied as shown in the examples of current measures of resource utilization given in Table III.

TABLE III
Examples of current measures of resource utilization

Example 1: 16 chassis, 224 blades, 66 switches,
224 host operating systems (* weight of 3 =
672), 9,500 virtual servers, 950 guest operating
systems (* weight of 4 = 3800) = 14278 => green
Example 2: 20 chassis, 280 blades, 82 switches,
280 host operating systems (* weight of 3 =
840), 12,320 virtual servers, 1,232 guest operating
systems (* weight of 4 = 4928) = 18,470
weighted endpoints => yellow
Example 3: 8 chassis, 112 blades, 34 switches,
112 host operating systems (* weight of 3 =
336), 4,500 virtual servers, 4,500 guest operating
systems (* weight of 4 = 18000) = 22,990
weighted endpoints => red
Example 4: 100 chassis, 1400 blades, 400 switches,
1400 host operating systems (* weight of
3 = 7200) = 9,100 weighted endpoints => green

In one embodiment, the application projects how many additional endpoints of a given endpoint type may be supported given a set of endpoint patterns, based on the difference between the current weighted endpoint value and the “green” value range label. To that end, Table IV shows examples of patterns that may be used.

TABLE IV
Examples of management patterns used in determining
how many additional endpoints can be supported

Example 1: A highly virtualized, low-guest-operating-system pattern in
which:
(i) each chassis is assumed to have 14 blades, 4 switches, and 2 top-of-
rack switches;
(ii) each blade has 44 virtual servers; and
(iii) 10% of the virtual servers have guest operating systems.
Example 2: A highly virtualized, low-guest-operating-system pattern in
which:
(i) each chassis is assumed to have 14 blades, 4 switches, and 2 top-of-
rack switches;
(ii) each blade has 44 virtual servers; and
(iii) 100% of the virtual servers have guest operating systems.
Example 3: A host operating system pattern in which:
(i) each chassis is assumed to have 14 blades, 4 switches, and 2 top-of-
rack switches; and
(ii) each blade has 1 operating system installed.

In one embodiment, to determine capacity relative to these patterns, the weighted endpoint result is subtracted from the green threshold value (e.g. 16,000) to determine the remaining weighted endpoint capacity, which is then divided by the weighted endpoint value for a single chassis using that pattern. Specifically, following is the formula to determine how many additional chassis can be managed for each pattern, in the case of chassis endpoints:

TABLE IV
Examples of facilitating determination of how many additional chassis
endpoints can be supported, based on management patterns

Example 1: A highly virtualized, low-guest-operating-system pattern -
remaining weighted endpoint capacity out of a maximum threshold of
927 (where the maximum threshold is determined based on 1 chassis, 14
blades, 6 switches, 14 host operating systems * weight 3, 616 virtual
servers, 62 guest operating systems * weight 4)
Note: If no endpoints are currently managed, then this metric shows
17 chassis.
Example 2: A highly virtualized, high-guest-operating-system pattern -
remaining weighted endpoint capacity out of a maximum threshold of
3,143 (where the maximum threshold is determined based on 1 chassis, 14
blades, 6 switches, 14 host operating systems * weight 3, 616 virtual
servers, 616 guest operating systems * weight 4)
Note: If no endpoints are currently managed, then this metric shows
5 chassis.
Example 3: A host operating system pattern - remaining weighted endpoint
capacity out of a maximum threshold of 63 (where the maximum threshold
of 63 is determined based on 1 chassis, 14 blades, 6 switches, 14 host
operating systems * weight 3)
Note: If no endpoints are currently managed, then this metric shows
246 chassis.

Accordingly, the different processing and/or resource consumption requirements of different endpoint types may be used to determine one or more maximum numbers of additional endpoints that can be potentially managed given a set of resources. Depending on the embodiment, the one or more maximum numbers of additional endpoints may pertain to endpoints of one or multiple distinct endpoint types. The count of endpoints of different types, that are managed by the application, may then be tailored based on the maximum numbers, thereby facilitating usage of the set of resources in a more efficient manner at least in some cases—at least relative to alternative approaches in which the processing and resource consumption requirements of different endpoint types are not taken into account.

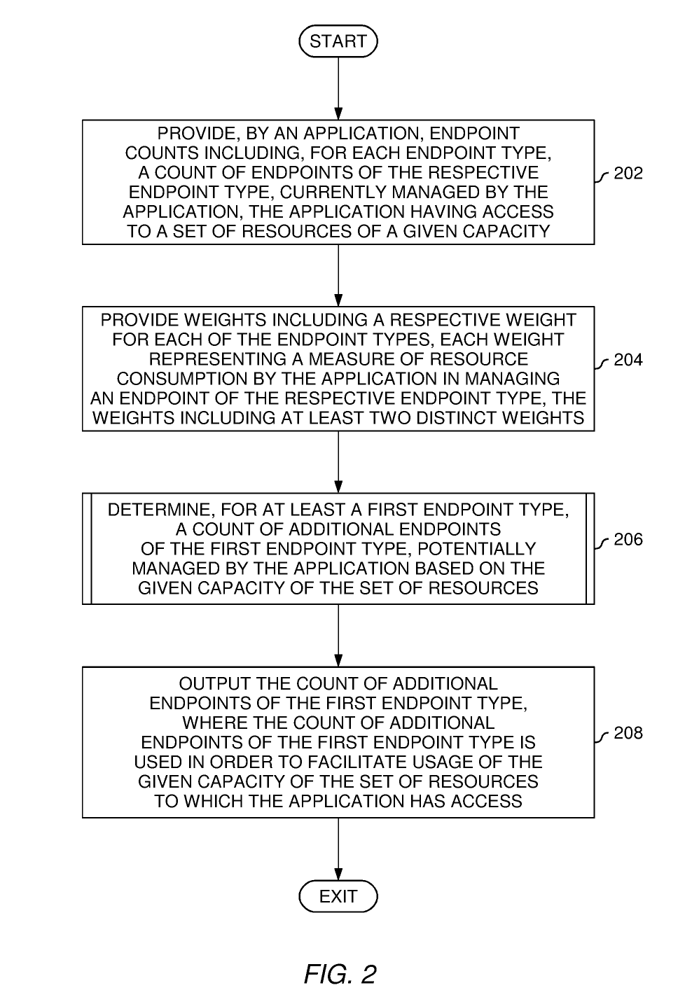

FIG. 2 is a flowchart depicting a method 200 to facilitate endpoint management based on endpoint type, according to one embodiment presented in this disclosure. As shown, the method 200 begins at step 202, where the application 102 provides endpoint counts including, for each endpoint type, a count of endpoints of the respective endpoint type, currently managed by the application. At step 204, the application 102 provides weights including a respective weight for each of the endpoint types. In one embodiment, each weight represents a measure of resource consumption by the application in managing an endpoint of the respective endpoint type. In some embodiments, the weights include at least two distinct weights, e.g., two distinct numerical values.

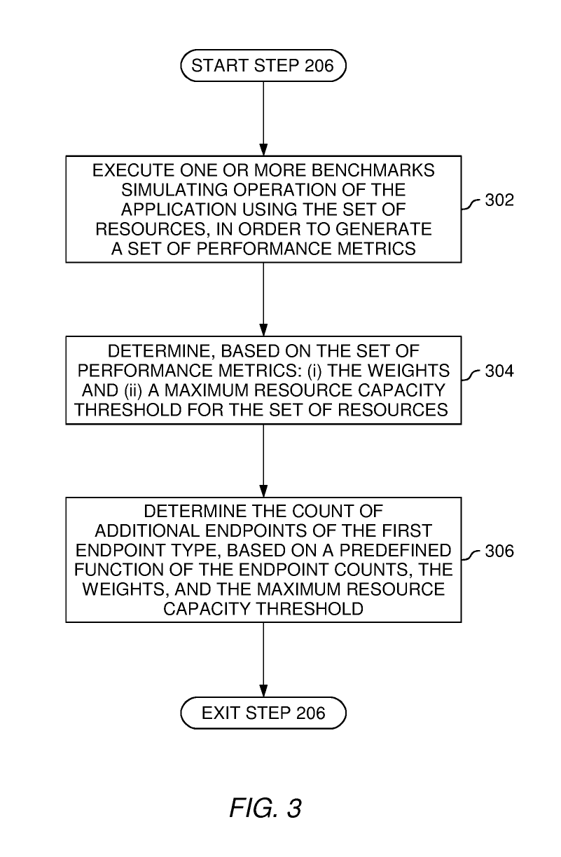

At step 206, the application 102 determines, for at least a first endpoint type, a maximum count of additional endpoints of the first endpoint type, potentially managed by the application based on the given capacity of the set of resources. The set of resources includes those resources designated for use by the application. In embodiments, where the application executes on a management appliance, the set of resources includes the hardware resources of the management appliance. The capacity of the set of resources refers to an extent of resources that the set represents as a whole, regardless of any current utilization of the set of resources. For example, assume that the current level of utilization of the set of resources is fifty percent. The capacity of the set of resources refers to the full extent of the set of resources—and not merely the portion of the set of resources remaining under the current level of utilization. Step 206 is described in further detail below in conjunction with FIG. 3. At step 208, the application 102 outputs the maximum count of additional endpoints of the first endpoint type. In one embodiment, the maximum count of additional endpoints of the first endpoint type is used to facilitate usage of the given capacity of the set of resources to which the application 102 has access. After the step 208, the method 200 terminates.

FIG. 3 is a flowchart depicting a method 300 to determine a maximum count of additional endpoints potentially managed, according to one embodiment presented in this disclosure. The method 300 corresponds to the step 206 of FIG. 2. As shown, the method 300 begins at step 302, where one or more benchmarks are executed using the set of resources, in order to generate a set of performance metrics. At least in some embodiments, the one or more benchmarks simulate operation of the application 102. At step 304, the weights are determined based on the set of performance metrics and according to a set of predefined rules. The set of predefined rules may also specify how to determine a maximum resource capacity threshold for the set of resources, based on the set of performance metrics.

For example, the set of predefined rules may specify to generate a system of linear equations based on the performance metrics, where each linear equation represents a different benchmark or execution instance thereof. The set of predefined rules may also specify to programmatically solve, at least in part, the system of linear equations, in order to determine ratios of variables in the linear equation. For instance, assume that a first benchmark execution, in which only four-hundred switches are managed, yields performance metrics reflecting one percent utilization on the part of the application. Assume also that a second benchmark execution, in which only one-hundred guest operating systems are managed, also yields performance metrics reflecting one percent utilization on the part of the application. From these performance metrics, the application may generate a system of linear equations including 400*s+0*g=0.01*u and 0*s+100*g=0.01*u. In the linear equations, s represents the measure of resource consumption of the application in managing a single switch, g represents the measure of resource consumption of the application in managing a single guest operating system, and u represents the maximum potential utilization of the application given the capacity of the set of resources to which the application has access.

In solving the system of linear equations at least in part, the application may programmatically determine that 4*s=1*g. Accordingly, the application may infer that the resource burden in managing a guest operating system is four times as great as that of managing a switch. The application may also programmatically determine that u=40000*s=10000*g. Accordingly, the application may infer that the capacity of the set of resources available to the application is sufficient for managing up to forty thousand switches or, alternatively, up to ten thousand guest operating systems. Consequently, the application may use systems of linear equations to model resource consumption behavior of the application in managing endpoints of various types. Although the above example is described with reference to a system of two linear equations, systems of linear equations involving any number of equations and any number of variables in each equation are broadly contemplated by the present disclosure.

At step 306, the application 102 may determine the maximum count of additional endpoints of the first endpoint type, based on a predefined function of: the endpoint counts, the weights, and the maximum resource capacity threshold. In one embodiment, the predefined function is a weighted sum of the endpoint counts. After the step 306, the method 300 terminates.

Accordingly, at least some embodiments presented in this disclosure provide techniques to facilitate endpoint management based on endpoint type. By using the techniques disclosed herein, the different processing and resource consumption requirements of different endpoint types may be used to determine a maximum number of additional endpoints that can be potentially managed given a set of resources. The set of resources may be used more efficiently at least in some cases, at least relative to alternative approaches in which the processing and resource consumption requirements of different endpoint types are not taken into account.

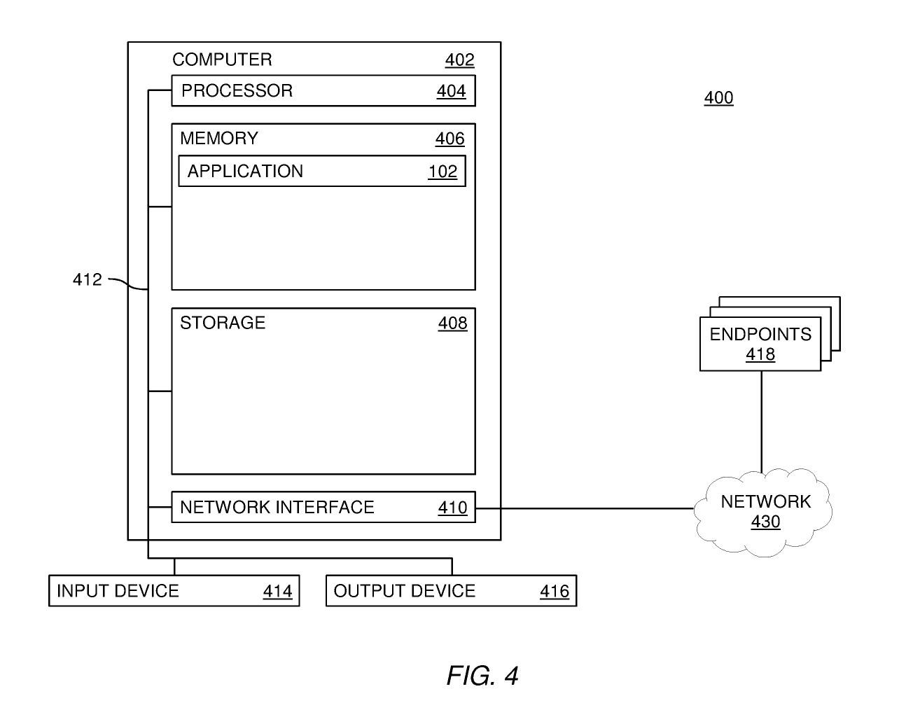

FIG. 4 is a block diagram illustrating components of a networked system 400 configured to manage meta-applications, according to one embodiment presented in this disclosure. The networked system 400 includes a computer 402. The computer 402 may also be connected to other computers via a network 430. In general, the network 430 may be a telecommunications network and/or a wide area network (WAN). In a particular embodiment, the network 430 is the Internet. In one embodiment, the computer 402 is a management appliance configured to manage endpoints of different types and according to the techniques disclosed herein.

The computer 402 generally includes a processor 404 connected via a bus 412 to a memory 406, a network interface device 410, a storage 408, an input device 414, and an output device 416. The computer 402 is generally under the control of an operating system. Examples of operating systems include UNIX, versions of the Microsoft Windows® operating system, and distributions of the Linux® operating system. More generally, any operating system supporting the functions disclosed herein may be used. The processor 404 is included to be representative of a single CPU, multiple CPUs, a single CPU having multiple processing cores, and the like. Similarly, the memory 406 may be a random access memory. While the memory 406 is shown as a single identity, it should be understood that the memory 406 may comprise a plurality of modules, and that the memory 406 may exist at multiple levels, from high speed registers and caches to lower speed but larger DRAM chips. The network interface device 410 may be any type of network communications device allowing the computer 402 to communicate with other computers via the network 430.

The storage 408 may be a persistent storage device. Although the storage 408 is shown as a single unit, the storage 408 may be a combination of fixed and/or removable storage devices, such as fixed disc drives, solid state drives, floppy disc drives, tape drives, removable memory cards or optical storage. The memory 406 and the storage 408 may be part of one virtual address space spanning multiple primary and secondary storage devices.

The input device 414 may be any device for providing input to the computer 402. For example, a keyboard and/or a mouse may be used. The output device 416 may be any device for providing output to a user of the computer 402. For example, the output device 416 may be any conventional display screen or set of speakers. Although shown separately from the input device 414, the output device 416 and input device 414 may be combined. For example, a display screen with an integrated touch-screen may be used.

As shown, the memory 406 of the computer 402 includes the application 102 of FIG. 1. The application 102 is operatively connected to endpoints 418 via the network 430. By configuring the application 102 to manage the endpoints 418 according to the techniques disclosed herein, the application 102 may use resources of the computer 402 more efficiently at least in some cases.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects presented in this disclosure may be embodied as a system, method or computer program product. Accordingly, aspects disclosed herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects disclosed herein may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects disclosed herein may be written in any combination of one or more programming languages, including an object oriented programming language such as Java, Smalltalk, C++ or the like and conventional procedural programming languages, such as the “C” programming language or similar programming languages. The program code may execute entirely on the computer of a user, partly on the computer of the user, as a stand-alone software package, partly on the computer of the user and partly on a remote computer, or entirely on the remote computer or server. In the latter scenario, the remote computer may be connected to the computer of the user via any type of network, including a local area network (LAN) or a wide area network (WAN), or the connection may be made to an external computer (for example, through the Internet using an Internet Service Provider).

Aspects presented in this disclosure are described above with reference to flowchart illustrations or block diagrams of methods, apparatus (systems) and computer program products according to embodiments disclosed herein. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For convenience, the Detailed Description includes the following definitions which have been derived from the “Draft NIST Working Definition of Cloud Computing” by Peter Mell and Tim Grance, dated Oct. 7, 2009.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth and active user accounts). Resource usage can be monitored, controlled and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems or storage, but has control over the deployed applications and possibly application hosting environment configurations.

Infrastructure as a Service (IaaS): the capability provided to the consumer is to provision processing, storage, networks and other fundamental computing resources where the consumer is able to deploy and run arbitrary software, which can include operating systems and applications. The consumer does not manage or control the underlying cloud infrastructure but has control over operating systems storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity and semantic interoperability. At the heart of cloud computing is an infrastructure comprising a network of interconnected nodes.

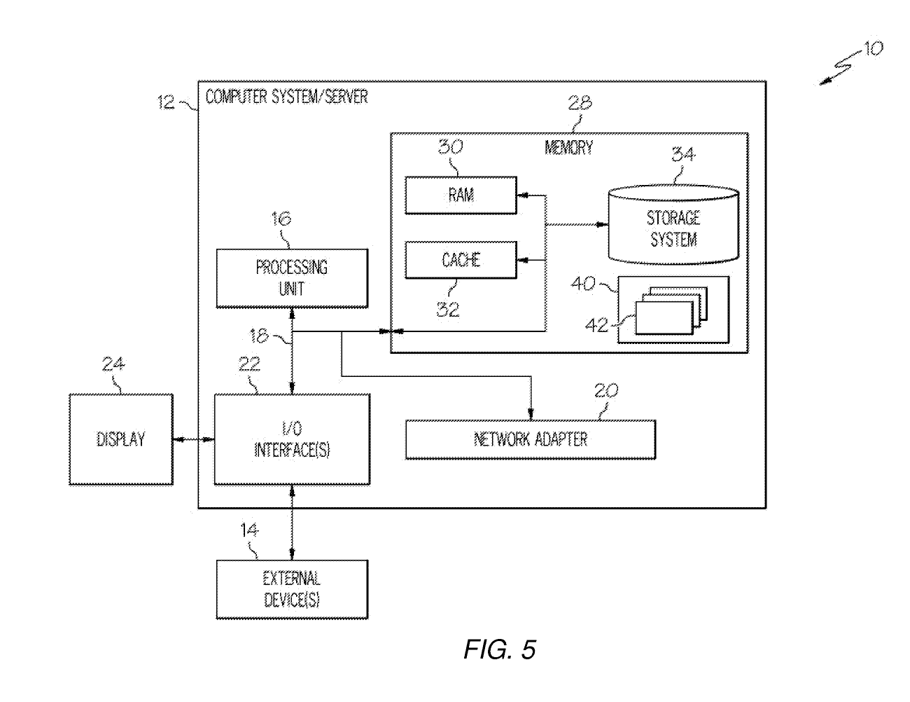

Referring now to FIG. 5, a schematic of an example of a cloud computing node endpoint to be managed by the application is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

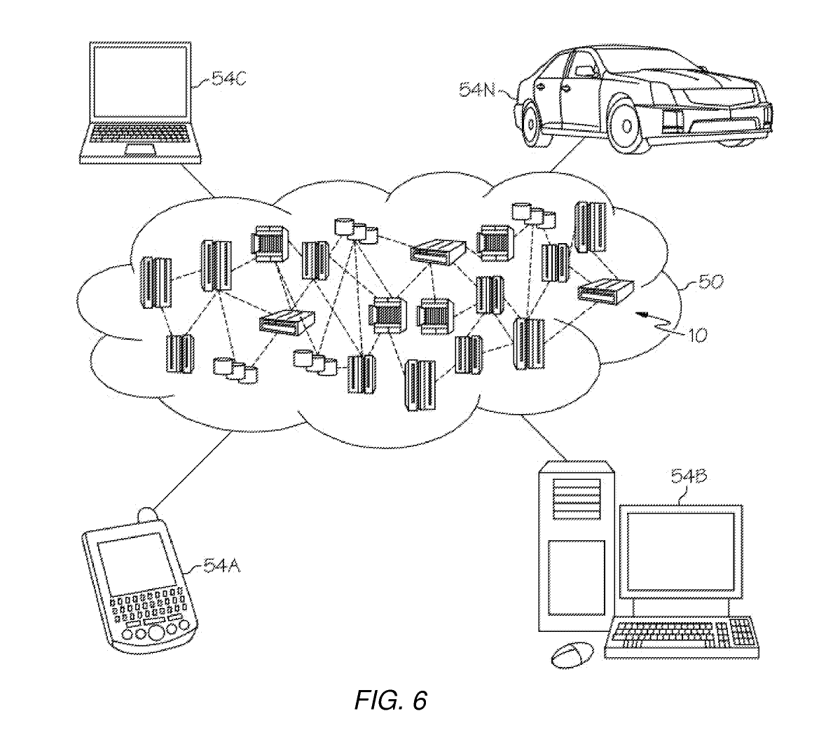

Referring now to FIG. 6, illustrative cloud computing environment 50 including endpoints to be managed by the application is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 21 are intended to be illustrative only and that computing nodes 10 and cloud computing environment 50 can communicate with any type of computerized device over any type of network and/or network addressable connection (e.g., using a web browser).

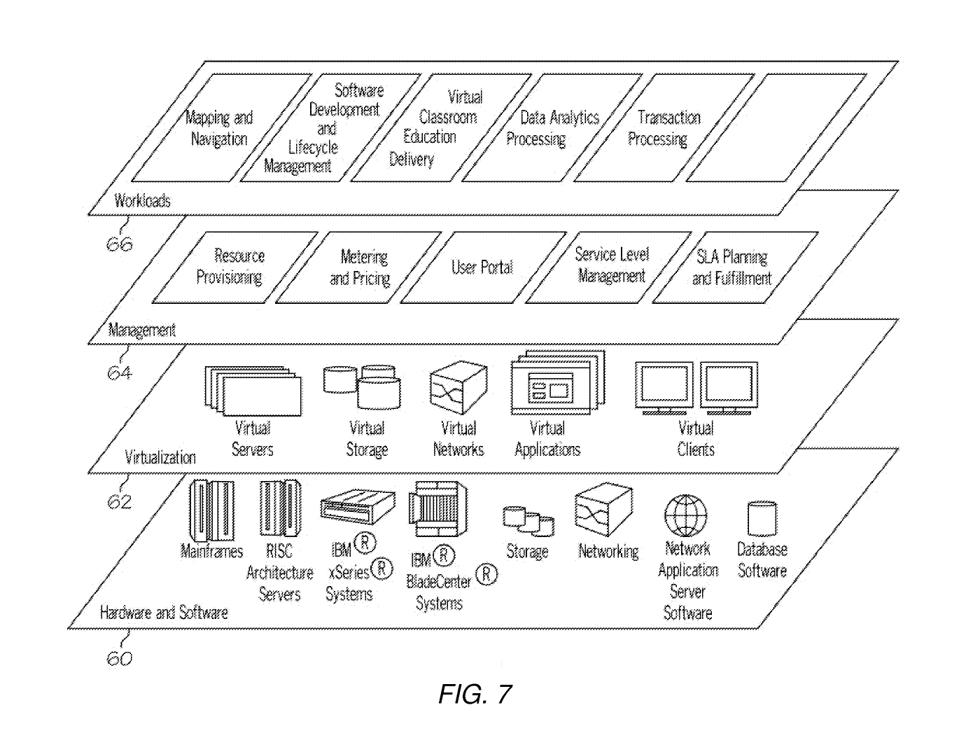

Referring now to FIG. 7, a set of functional abstraction layers provided by cloud computing environment 50 (FIG. 6) of endpoints to be managed by the application is shown. It should be understood in advance that the components, layers and functions shown in FIG. 21 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2®, database software. (IBM, zSeries, pSeries, xSeries, BladeCenter, WebSphere, and DB2 are trademarks of International Business Machines Corporation registered in many jurisdictions worldwide)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. The SLA generally specifies the services, priorities, responsibilities, guarantees and/or warranties that exist between a service provider and a customer.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the embodiments presented herein, the application and/or endpoints may execute in the cloud. The application may determine a maximum count of additional endpoints potentially managed by the application. Thus, the user may access the application from any computing system attached to a network connected to the cloud (e.g., the Internet) and be charged based on the processing environment(s) used.

The flowchart and block diagrams in the Figures illustrate the architecture, functionality, and operation of possible implementations of systems, methods and computer program products according to various embodiments disclosed herein. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams or flowchart illustration, and combinations of blocks in the block diagrams or flowchart illustration, can be implemented by special-purpose hardware-based systems that perform the specified functions or acts, or combinations of special purpose hardware and computer instructions.

While the foregoing is directed to embodiments presented in this disclosure, other and further embodiments may be devised without departing from the basic scope of contemplated embodiments, and the scope thereof is determined by the claims that follow.

What is claimed is:

1. A computer-implemented method to facilitate endpoint management based on endpoint type, the method comprising:
providing, by an application, a plurality of endpoint counts comprising, for each of a plurality of endpoint types, a count of endpoints of the respective endpoint type, currently managed by the application, the application having access to a set of resources of a given capacity;
providing a plurality of weights comprising a respective weight for each of the plurality of endpoint types, each weight representing a measure of resource consumption by the application in managing an endpoint of the respective endpoint type, the plurality of weights including at least two distinct weights;
determining, by operation of one or more computer processors and for at least a first endpoint type of the plurality of endpoint types, a count of additional endpoints of the first endpoint type, potentially managed by the application, based on the given capacity of the set of resources; and
outputting the count of additional endpoints of the first endpoint type, wherein the count of additional endpoints of the first endpoint type is used in order to facilitate usage of the given capacity of the set of resources to which the application has access.

2. The computer-implemented method of claim 1, the given capacity of the set of resources is predefined, wherein the plurality of weights are determined based on a set of performance metrics generated from executing one or more predefined benchmarks simulating operation of the application using the set of resources, wherein the set of performance metrics is used to determine a plurality of resource capacity thresholds for the predefined capacity of the set of resources, the plurality of resource capacity thresholds including a maximum resource capacity threshold and one or more low or medium resource capacity thresholds.

3. The computer-implemented method of claim 2, wherein the count of additional endpoints of the first endpoint type is determined based on a predefined function of: (i) the plurality of endpoint counts; (ii) the plurality of weights; and (iii) the maximum resource capacity threshold;
wherein the set of resources consists of a set of resources available to a management appliance on which the application is configured to execute, wherein each weight comprises a numeric value, wherein the resource capacity threshold comprises a numeric value, wherein the predefined function comprises a weighted sum, wherein the count of additional endpoints comprises a projected maximum count.

4. The computer-implemented method of claim 3, wherein the one or more predefined benchmarks are configured to, in respective instances, measure each performance metric selected from response time, path length, and resource utilization, wherein path length comprises a count of processor instructions issued to process a given message;
wherein the count of additional endpoints of the first endpoint type is conveyed to a user, wherein the application additionally manages each additional endpoint of the count of additional endpoints of the first endpoint type upon receiving confirmation from the user.

5. The computer-implemented method of claim 4, wherein usage of the predefined capacity of the set of resources is facilitated to a further extent than when the count of additional endpoints is neither determined nor output, wherein the application is configured to, in respective instances, manage each endpoint type selected from hardware endpoints, operating system endpoints, and virtual endpoints.

6. The computer-implemented method of claim 5, wherein the application is configured to, in respective instances, manage each hardware endpoint selected from a chassis, a switch, and a blade, wherein the application is configured to, in respective instances, manage each operating system endpoint selected from: (i) a guest operating system executing on a virtual server and (ii) a host operating system executing on a physical server; wherein the application is configured to, in respective instances, manage each virtual endpoint selected from a virtual server and a virtual switch;
wherein the application is configured to convey, for each endpoint type: (i) the count of endpoints currently managed by the application and (ii) the count of additional endpoints potentially managed by the application given the predefined capacity of the set of resources.

7. The computer-implemented method of claim 6, wherein the count of additional endpoints of the first endpoint type, potentially managed by the application is determined based further on a desired endpoint management pattern selected from a plurality of distinct, predefined endpoint management patterns;
wherein the plurality of endpoint types are predefined, wherein the application is configured to convey, in respective instances, each count of additional endpoints selected from a count of hardware endpoints, a count of operating system endpoints, and a count of virtual endpoints;
wherein the application is further configured to, in respective instances, convey each resource utilization type of the management appliance, selected from processor utilization, memory utilization, storage utilization, and network utilization;
wherein the weight for the guest operating system is higher than the weight for the host operating system, wherein the weight for the host operating system is higher than each weight selected from the weight for the chassis, the weight for the blade, the weight for the switch, and the weight for the virtual server;
wherein the application is further configured to:
only upon determining that the maximum resource capacity is exceeded, conveying to the user that the maximum resource capacity is exceeded; and
only upon determining a first one of the one or more medium resource capacity thresholds is exceeded, conveying to the user that the first medium resource capacity threshold is exceeded.
